(19) United States
(12) Patent Application Publication
(10) Pub. No.: US 2026/0098793 A1
(43) Pub. Date: Apr. 9, 2026

(54) WIRE BOND PULL TEST APPARATUS, TEST EQUIPMENT, TEST METHOD

(71) Applicant: Skyworks Solutions, Inc., Irvine, CA (US)

(72) Inventors: Elmer Rad Bais Tabio, Mexicali (MX); Aldrin Quinones Garing, Mexicali (MX); Felipe Moreno Sandoval, Mexicali (MX); Elvis Texon Broncano, Mexicali (MX); Arvin Romero Dela Peña, Mexicali (MX)

(21) Appl. No.: 19/353,489

(22) Filed: Oct. 8, 2025

Related U.S. Application Data
(60) Provisional application No. 63/705,422, filed on Oct. 9, 2024.

(51) Int. Cl. G01N 3/14; G01N 3/04

(52) U.S. Cl. CPC G01N 3/14; G01N 3/04; G01N 2203/0017; G01N 2203/0035; G01N 2203/005; G01N 2203/0067; G01N 2203/0252; G01N 2203/028

(57) ABSTRACT

A wire bond pull test apparatus for detecting a bond failure or wire breakage during a vertical tensile strength testing of a bonded wire under test. The test apparatus has a clamp structure with clamping elements and a controllable actuator coupled to at least one the clamping elements and configured to drive the movement of the clamping elements relative to each other to clamp the wire under test.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The present invention relates to a wire bond pull test apparatus for detecting a bond failure or wire breakage during a vertical tensile strength testing of a bonded wire under test. The present invention further relates to a wire bond pull test equipment and a test method.

### TECHNICAL BACKGROUND

Single-end bonded wire technology is an important feature in the semiconductor industry. It has been actively used in a variety of aspects of semiconductor packaging, for instance, in 3-dimensions stacked die packaging, system-in-package (SiP), flip-chip bonding and the like. Vertical bonded wire typically employs single-end bonded wire technology.

The conventional wire bonding typically refers to double-end bonding, where the wire is attached at both ends to make a weld. For testing the reliability of the wire bonding, wire bonding pull test for double-end bonding play an important role. It typically applies an upward force upon wires and effectively pulls the wire away from the substrate or die for example by employing a hook until there is a bond failure or in a worst case scenario a lifted ball. By analyzing the results of the pull test, manufacturers can fine-tune wire bond parameters and optimize the manufacturing process, resulting in improved efficiency and cost effectiveness.

Known wire pull testing is thus mainly focused on the pull testing of wire bonds having double-end connectivity.

### SUMMARY

There is a need to provide a wire bond pull test apparatus that is capable to test the reliability of single-end bonded wires.

According to the first aspect, the present disclosure presents a wire bond pull test apparatus for detecting a bond failure or wire breakage during a vertical tensile strength testing of a bonded wire under test, the test apparatus comprising: a clamp structure including a first clamping element and a second clamping element, wherein the first clamping element and the second clamping element are arranged substantially parallel to each other and defining an opening for placing a single-end bonded wire under test between the first clamping element and the second clamping element, wherein at least one of the first clamping element and the second clamping element is configured to enable a movement towards and from each other such to clamp the single-end bonded wire under test in the opening between the first clamping element and the second clamping element and to release the single-end bonded wire under test, respectively; a controllable actuator coupled to at least one of the first clamping element and the second clamping element, wherein the controllable actuator is arranged and configured to drive the movement of the first clamping element and the second clamping element relative to each other such that the single-end bonded wire under test is clamped in the opening between the first clamping element and the second clamping element and released, respectively.

According to a second aspect, the present disclosure presents a wire bond pull test equipment for detecting a bond failure or wire breakage during a vertical tensile strength testing of a bonded wire under test, the test equipment comprising: a wire bond testing platform comprising a test area which is configured to receive a single-end bonded wire under test; at least one wire bond pull test apparatus for detecting a bond failure or wire breakage during the vertical tensile strength testing of the bonded wire under test coupled to the wire bond pull test equipment, the test apparatus comprising: a clamp structure including a first clamping element and a second clamping element arranged substantially parallel to each other and defining an opening for placing a single-end bonded wire under test between the first clamping element and the second clamping element, wherein at least one of the first clamping element and the second clamping element is configured to enable a movement towards and from each other such to clamp the single-end bonded wire under test in the opening between the first clamping element and the second clamping element and to release the single-end bonded wire under test, respectively; a controllable actuator coupled to at least one of the first clamping element and the second clamping element, wherein the controllable actuator is arranged and configured to drive the movement of the first clamping element and the second clamping element relative to each other such that the single-end bonded wire under test is clamped in the opening between the first clamping element and the second clamping element and released, respectively.

According to a third aspect, the present disclosure presents a method for detecting a bond failure or wire breakage during a vertical tensile strength testing of a bonded wire under test, the method comprising: placing at least one wire bond pull test apparatus in a wire bond pull test equipment for detecting a bond failure or wire breakage during the vertical tensile strength testing of bonded wire under test; placing a single-end bonded wire under test in the wire bond testing platform; moving the first clamping element and the second clamping element from each other such to increase an opening between the first clamping element and the second clamping element; placing a single-end bonded wire under test in the opening between the first clamping element and the second clamping element; driving the first clamping element and the second clamping element to clamp a single-end wire under test; pulling the single-end bonded wire under test to conduct the vertical tensile strength testing; recording at least one test record of the vertical tensile strength testing.

The present invention provides a novel apparatus for wire bond pull test for detecting a bond failure or wire breakage during a vertical tensile strength testing of bonded wires under test. Compared to known solution described in the introductory part, the apparatus according to aspects of this invention fills the gap in this technical field such that the bond strength and the bond failure modalities can now also be measured or evaluated for a single-end bonded wire. For this purpose, the wire bond pull test apparatus comprises a clamp structure and a controllable actuator.

The present invention performs a wire pull test on a single connection wire, e.g. a vertical bonded wire, such that it can achieve a comparable accuracy and precision without the need to fix both ends of the wire under test. The wire bond pull test for the single-end bond wire under test enables an early detection of the wire strength after bonding, enhances the wire bond stability by determining the wire pull strength especially during the machine setup or device conversion, reduces the risk of single-end bonded wire for a broken wire, inconsistent tail, and sticky wire by defining the most optimal parameters setting based on the test result. Further, it thus is suited to improve the productivity and the overall effectivity.

Advantageous configurations and developments emerge from the further dependent claims and from the description with reference to the figures of the drawings.

In a possible configuration of the test apparatus, the controllable actuator comprises at least one solenoid. A solenoid is a type of electromagnet formed by a helical coil of wire whose length is substantially greater than its diameter, which generates a controlled magnetic field. The coil can produce a uniform magnetic field in a volume of space when an electric current is passed through it. A solenoid may serve as an actuator mechanism to apply or release a force on an item based on the electrical input. As such, the clamp and release operation of the clamp structure may be controlled through the electronically control of the solenoid which acts as an actuating control element. Thus, the solenoid is configured to offer precise control over the force and movement of the clamp and release operation. It may also have the potential to allow for automation in various application.

In a possible configuration of the test apparatus, the test apparatus further comprises at least one controller circuit that is electrically coupled to the solenoid. The controllable actuator may also comprise other electronic control elements to perform the driving of the movement of the first clamping element and the second clamping element. The at least one solenoid could be electrically coupled to other controller circuit to realize relative fast control and communication process.

In a possible configuration of the test apparatus, the apparatus further comprises at least one controller circuit that is electrically and mechanically hybrid coupled to the at least one solenoid. The controllable actuator may also comprise other electronic or mechanical control elements to perform the driving of the movement of the first clamping element and the second clamping element. The at least one solenoid can be electrically and mechanically hybrid coupled to other control elements of the controllable actuator to improve the flexible design of controllable actuator and the efficiency of heat dissipation.

In a possible configuration of the test apparatus, the apparatus further comprises at least one electronic circuit electrically coupled to the controllable actuator, or being part of the controllable actuator. The electronic circuit may comprise different combinations of the following circuits according to different use context: a power supply circuit, a controller circuit, a timer circuit, or more. A power supply circuit is an electrical circuit that supplies electric power to any circuit that need electrical power. It converts electric current from a source to corresponding correct voltage, current and frequency to power the load. The power supply circuit may be a programmable power supply circuit to supply power more precisely and efficiently. A controller circuit—or shortly also referred to as controller—is an electronic circuit that is designed to manage, control and/or regulate the operation of other devices or systems. It receives input signals (such as control, test or measurement signals), processes them, and generates output signals to manage and regulate the behavior, status or signals of the connected devices or systems or components thereof. It may be a microcontroller comprising at least one processor core along with memory and programmable input/output peripherals. It may be a separate control circuit that manages the access and distribution of the memory that sends control signals to other electronic circuit units. The controller circuit may also be a programmable circuit such as an FPGA or PLD. It goes without saying that the controller circuit may also be implemented in software. A timer circuit is a type of clock that starts from a specified time duration and stops when reaching the setting time limit. It can be implemented through hardware with mechanical or electromechanical mechanism. It can be implemented through software with a programmable logic controller. A timer circuit may start counting down with a predetermined time period for each operation of the vertical tensile strength testing, such that when no operation is conducted or completed with the predefined time period of countdown, the apparatus is configured to be reset to a default position or be cut off from a power supply. As such, it can save the energy of the apparatus. The electronic circuit can be electrically coupled to the controllable actuator in order to achieve a more flexible design of the apparatus, or at least partially integrated with the controllable actuator in order to achieve a more compact design of the apparatus.

In a possible configuration of the test apparatus, the opening defined by the first clamping element and the second clamping element has a cross section, wherein the shape of the cross section of the opening corresponds to the shape of a cross section of a single-end bonded wire under test. The cross section of the single-end bonded wire under test may be circular, oval, square, triangle, polygonal or may have other regular or irregular forms. The cross section of the opening with the surface that corresponds to the form of the single-end bonded wire under test may make the clamp structure and the single-end bonded wire under test fit more suitable when the single-end bonded wire is clamped in the opening defined by the first clamping element and the second clamping element. Therefore, it may reduce test errors due to poor fit or grip between the clamp structure and the single-end bonded wire during pull testing.

In a possible configuration of the test apparatus, the first clamping element and the second clamping element each comprises a clamping surface for clamping a single-end bonded wire under test, wherein the clamping surfaces have a substantially flat surface. For example, in case the cross section of the single-end bonded wire under test is square, rectangular or simply flat, it is then preferable when the clamping surface also comprises a flat surface. The flat surface of the cross section of the opening should preferably corresponds to the square form of the cross section of the single-end bonded wire under test. This may make the clamp structure and the single-end bonded wire under test fit more suitable when the single-end bonded wire under test is clamped in the opening defined by the first clamping element and the second clamping element. Therefore, it may reduce test errors due to poor fit or grip of the clamp structure and the single-end bonded wire during pull testing.

In a possible configuration of the test apparatus, the first clamping element and the second clamping element each comprises a clamping surface for clamping a single-end bonded wire under test, wherein the clamping surfaces have a substantially convex surface. For example, in case the cross section of the single-end bonded wire under test is circular or oval, it is then preferable when the clamping surface comprises a convex surface. The convex surface of the cross section of the opening then basically corresponds to the round form of the cross section of the single-end bonded wire under test. This may make the clamp structure and the single-end bonded wire under test fit more suitable when the single-end bonded wire under test is clamped in the opening defined by the first clamping element and the second clamping element. Therefore, it may reduce test errors due to poor fit or grip of the clamp structure and the single-end bonded wire during testing.

In a possible configuration of the test apparatus, the opening defined by the first clamping element and the second clamping element is configured for inserting and placing a vertical bonded wire in the opening between the first clamping element and the second clamping element. The vertically arranged bonded wire applies a single-end connectivity technology. A vertical bonded wire can be described as a wire that is bonded in a configuration where it is primarily perpendicular arranged to the surface of the chip or substrate. The wire bond may start with a ball bond or a wedge bond on the die pad and then rises vertically to the bond pad on the substrate or lead frame. The wire may then be terminated with a wedge bond or another ball bond, creating a loop that is elevated above the surface. Vertical bonded wires can be referred to vertical interconnections in part of a 3D stacking process, which connect different layers or dies within a stacked package. In certain radio frequency or microwave applications, vertical bonded wire can be used to minimize parasitic inductance and capacitance by keeping bond wires as short and straight as possible. This can help in maintaining the integrity of high-frequency signals. In the context of wire shielding, the vertical bonded wire technology benefits for the advanced design rules in terms of compact packaging, improves the wire altitude requirement and consumes less of wire usage compared to the wire fence shielding process.

In a possible configuration of the test apparatus, the apparatus further comprises a spring arranged between the first clamping element and the second clamping element, wherein in a clamped condition of the single-end bonded wire under test the spring is configured to exert a predefined force on the single-end bonded wire under test. The spring-arranged clamping elements may assist maintaining the correct tension on the wire and thus preventing slack or excessive tightness, which could negatively affected the wire under test, such as leading to poor test performance, wire deformation or wire breakage in between the clamp.

In a possible configuration of the test apparatus, the first clamping element and the second clamping element are further configured to be moveable relative to each other along a direction that is perpendicular to the single-end bonded wire under test. The single-end bonded wire under test may be a vertical bonded wire. The movement of the first clamping element and the second clamping element along a direction that is perpendicular to the single-end bonded wire may reduce test errors due to inappropriate clamping of the single-end bonded wire during testing, increasing the overall efficiency of the testing.

In a possible configuration of the test apparatus, at least one of the first clamping element and the second clamping element and in particular their corresponding clamping surfaces have a rough surface. This rough surface is configured such to prevent skidding of a single-end bond wire under test which is clamped in the opening between the first clamping element and the second clamping element. Rough surfaces on the clamping surfaces are suited to increase the friction between the clamping elements and the clamped wire under test and are thus ensuring that the clamped wire is fixed during the testing operation.

In a possible configuration of the test apparatus, the apparatus further comprises a base connector, wherein the base connector is coupled to the clamp structure. The base connector comprises a test interface which is configured to couple the test apparatus to an external wire bond pull test equipment. Alternatively, the test interface is also configured to couple the wire bond pull test apparatus to the external wire bond pull test equipment via a wire pull cartridge. When different test apparatuses need to be coupled to the wire bond pull test equipment, only this base connector needs to be detached without further disassembly of other components of the test apparatus. Similarly, the base connector can be attached to the wire bond pull test equipment. This enables the reuse of one test equipment for different testing needs.

In a possible configuration of the test apparatus, the apparatus further comprises a support element arranged between the base connector and the controllable actuator. The support element is configured to provide mechanical support for the controllable actuator. The mechanical support may be a bracket, a brace, a frame or the like. Mechanical support between the base connector and the controllable actuator ensures that the test apparatus remains stable during the testing. It may offer proper alignment and protection of the test apparatus from collapsing when the test apparatus is under malfunction. It may also help to reduce vibrations and associated noise during the testing.

In a possible configuration of the test apparatus, the first clamping element and the second clamping element comprise at least one of the following material: stainless steels, aluminum, high-strength alloys. Besides costs, in particular mechanical strength, corrosion resistance, thermal stability, recyclability and weight-to-strength ratio and the like should be taken into consideration when selecting suitable materials for the test apparatus. Most of the materials in the test apparatus should possess high tensile and compressive strength, making them capable of withstanding significant mechanical stress without breaking or deforming. Some metals, such as stainless steel and aluminum, also offer high corrosion resistance. This property protects the apparatus from degrading due to environmental exposure, such as temperature, humidity and chemicals, thereby extending the lifespan and reliability of the apparatus. The materials used in the test apparatus should maintain their properties over a wide range of temperatures, making them suitable for applications that involve extreme temperatures. Preferably, the material in the test apparatus can be recycled without significant degradation in material properties so as to reduce the environmental impact.

In a possible configuration of the test apparatus, the first clamping element and the second clamping element comprise a first elongated arm and a second elongated arm, respectively. The first elongated arm and the second elongated arm may be two symmetrical and separable elongated arms, which are joined with one or more springs. It defines a boarder opening between the first clamping element and the second clamping element, thus it may provide a more flexible, stable and easy-to-repair structure, which increases a degree of freedom of operation. The load distribution of the clamp structure may be also be more balanced.

In a possible configuration of the test apparatus, the first elongated arm comprises a first proximal end and a first distal end and the second elongated arm comprises a second proximal end and a second distal end. A spring is arranged between the first proximal end and the second proximal end. The controllable actuator may be coupled to at least one proximal end or at least one distal end to control the movement of the clamping elements. The first distal end and the second distal end of the first elongated arm and the second elongated arm may have a smaller or equal cross section area than the proximal ends of a first elongated arm and a second elongated arm. The first distal end and the second distal end of the first elongated arm and the second elongated arm may have a pair of point-shaped tips, a pair of a slant-shaped tips, a pair of a pointed-slant-shaped tips, a pair of a round-shaped tips, a pair of a square-shaped tips, or the like. It can be adapted to different kinds of test wire, providing a larger range of test types.

In a possible configuration of the test apparatus, the clamp structure comprises an elongated arm that comprises a proximal end and a distal end. This feature simplifies the design and reduce the weight of the clamp structure. It may also provide a more compact design and a more cost-effective stability design by further adopting less construction material by more or less maintaining the needed stability.

In a possible configuration of the test apparatus, the distal end comprises the first clamping element and the second clamping element, wherein a spring is arranged between the first clamping element and the second clamping element. The elongated arm further comprises a distal end comprising two branches. Those two branches may be the first clamping element and the second clamping element. The first clamping element and the second clamping element may be joined with a spring. The spring-arranged clamping elements may assist to maintain the correct tension on the wire, preventing slack or excessive tightness, which could negatively affected the wire under test, such as leading to poor test performance, wire deformation or wire breakage in between the clamp. The controllable actuator may be coupled to the proximal end or the distal end to control the movement of the clamping elements. It defines a more compact design of the apparatus. It may provide more precise operations and avoid disoperation.

In a possible configuration of the test equipment, the test equipment further comprises a pulling unit. The pulling unit is configured to apply an upwards directed force to the apparatus to conduct the vertical tensile strength testing when the single-end bonded wire under test is clamped in the opening between the first clamping element and the second clamping element. The single-end bonded wire is preferably be placed in the middle of the opening defined by the first clamping element and the second clamping element. The pulling force applied to the apparatus should be directed along the axial upward direction of the single-end bond wire under test. Thus, the test time may be saved and test efficiency may be improved.

In a possible configuration of the test equipment, the test equipment further comprises a detection unit. The detection unit is configured to record at least one test result, wherein the at least one test result is at least one of the following: ball lift, neck break, and wire break. Vertical tensile strength testing usually involves two types of testing: destructive test and non-destructive test. Destructive testing involves testing until the test object is damaged or even destroyed. The force applied is recorded. With the non-destructive test, the test continues until a previously defined force is reached. This force is maintained for a certain period of time and then released again. The vertical tensile strength testing ensures that wire bonds meet the required strength standards, reducing the risk of premature failure and increasing product reliability. The detection unit may ensure that the testing result is recorded in real-time and an in time decision on the testing could be made.

Ball lift, neck break and wire break are destructive test results. The ball lift occurrence indicates that the ball to bond pad interface is very weak. Poor wire bonder set-up and bond pad surface contamination are primary causes of ball lifting. Poor set-up includes improper parameter settings, unstable work piece holders, and worn-out tools. These result in poor initial welding and inadequate intermetallic formation between the bond pad and the ball. Neck break test result is a pull test break mode that breaks in between the wire and the ball bond. Neck break test result is considered to be of good adhesion between the ball bond and the surface of the bonding pad. The neck break pull test result indicates that the pull test strength is high versus the specification of the pulling force applied during the pull test. Wire break is a pull test break mode that breaks anywhere in between the wire. Wire break is considered to be of good adhesion between the ball bond and the surface of the bonding pad. Usually the wire break test result gives the highest bond pull value, closing to the ultimate tensile strength of the wire and indicating that the pull test strength is the highest among all the pull testing measurement.

Sometimes, the vertical tensile strength testing may follow a bond shear test. A quality ball bond can withstand up to ten times the wire pull destruct force but a low quality bond will still take more force to pull off than a wire pull test. Ball shear testing is used to assess the integrity of the ball-to-bonding pad interface in the ball bonding process. It is also a destructive test. Ball shear data reflects the intermetallic formation and its coverage of bonds. It is measured by gram force over the area of the ball formation.

In a possible configuration of the test equipment, the test equipment further comprises a timer unit. The timer unit is configured to generate a predefined time period for a countdown for each operation of the vertical tensile strength testing, such that when no operation is conducted or completed within the predefined time period, the apparatus is configured to be reset to a default position or be cut off from a power supply. While the timer circuit of the apparatus may focus on more the clamp and release movement of the clamp structure, the timer unit of the test equipment may also concentrate on the pull testing operation. However, the timer unit of the test equipment and the timer circuit of the apparatus may be a substitute or a backup for each other. The timer countdown function is essential for the vertical tensile strength testing. It can not only save energy in the testing process but also may ensure testing safety when the testing process is out of supervision.

In a possible configuration of the test equipment, the test equipment further comprises an evaluation device configured to evaluate whether the vertical tensile strength testing comprises at least one failure. A ball lift result may represent a wire pull failure. The ball lift occurrence indicates that the ball to bond pad interface is very weak. Poor wire bonder set-up and bond pad surface contamination are primary causes of ball lifting. Under the influence of this result, the test does not yield a sufficient time to be performed in order to yield further tensile test results. Other failures may be setting failures, operation failures or at least one malfunction, the arrival predefined time period of countdown or the like. The evaluation device can also indicate how strong a pull force applies to the device under test.

In a possible configuration of the test equipment, the test equipment further comprises a warning unit configured to generate at least one warning message in case the evaluation device has detected a failure. Under failure, the warning unit may send a warning message or signal via the test equipment or via wired or wireless communication to an external device or equipment.

In a possible configuration of the test equipment, the test equipment further comprises an output unit configured to output at least one test record of the vertical tensile strength testing. The output unit may output the at least one test record comprising at least one of the following information: the system settings; test result; failure. It may further comprise warning message or test logs. The system settings may include some permanent or non-permanent information of the test equipment. The test logs may comprise some information about the testing process or debug process. The test record may be output stepwise, which the test record may focus on one apparatus. The test record may be output with time-based, since different time slots there may be different test apparatuses on the run. Detailed test record may improve maintenance efficiency of the test equipment.

In a possible configuration of the test equipment, the output unit comprises at least one screen coupled to or at least partially embedded in the equipment. The at least one screen can be any kind of monitor, such as a liquid-crystal display screen. The liquid-crystal display screen can display a certain selected test record on site. The liquid-crystal display may also be touch screen such that the screen can also act as an input device. In particular, the touch screen provides a human-machine interface (HMI), which make the operation of the test equipment more efficient and comfortable to the user.

In a possible configuration of the test equipment, the output unit comprises at least one output interface which is configured to transfer a test record wired or wirelessly to an external device. The test record may comprise large amounts of test files, which information may not properly displayed on the screen. Therefore, the test record may also be transferred wired or wirelessly to an external device which can present and/or display the test files more efficiently.

In a possible configuration of the test equipment, the test equipment comprises further a memory configured to store at least one test record. The memory may be volatile or non-volatile. The test record may also be stored on a cloud memory, which can achieve a simultaneous cooperation between multiple people. In this case, the memory may store only the permanent information on testing and the address information of the local or external web server that hold the test record. Thus, the memory space can be largely saved and the equipment is more cost effective.

In a possible configuration of the test equipment, the test equipment comprises a processor configured to process the test record in a machine readable format. The machine-readable format may be a barcode, a matrix code, a quick response code or the like. The content of the test record may be directly encoded in the machine-readable format, or the address of the locally or external web server that store the test record may be encoded in the machine-readable format. The machine-readable format may be displayed on the screen of the test equipment, it may also be transferred to an external device. A device with a machine-readable format scanning function can scan and decode the information encoded in the machine-readable format. Therefore, the test recode can be more easily transferred within different devices.

In a possible configuration of the test method, the test method further comprises the step: removing the single-end bonded wire after test from the first clamping element and the second clamping element so that the first clamping element and the second clamping element are configured to be closed by default. A stray pulled single-end bonded wire is removed from the first clamping element and the second clamping element so that the first clamping element and the second clamping element are configured to be closed by default. During a tensile test, the single-end bonded wire under test may be deformed or broken by pulling, and usually the single-end bonded wire under test is no longer suitable for use in the facility and should be discarded. Usually at the completion of a vertical tensile strength testing, more or less stray pulled test wires remain on the clamping elements. The diameter of these test wires is usually close to the micron level, and a very small amount of test residue on the clamping elements can have a negative effect on the next test. The removal of the stray pulled single-end bonded wire from the first clamping element and the second clamping element can be used with physical disposal or chemical rinsing, such as be dumped on a trash bin or removed with ultrasonic rinsing, so as to prevent the test residue on the clamping elements from having a negative effect on the next test and to enable the clamping elements back to their default positions without the effect of test residue to save energy and extend the lifespan of the apparatus.

Where appropriate, the above-mentioned configurations and developments can be combined with each other as desired, as far as this is reasonable. Further possible configurations, developments and implementations of the invention also include combinations, which are not explicitly mentioned, of features of the invention which have been described previously or are described in the following with reference to the configuration s. In particular, in this case, a person skilled in the art will also assess individual aspects as improvements or supplements to the basic form of the present invention.

### BRIEF DESCRIPTION OF THE DRAWINGS

For a more comprehensive understanding of the invention and the advantages thereof, exemplary configurations of the invention are explained in more detail in the following description with reference to the accompanying drawing figures, in which like reference characters designate like parts and in which:

FIG. 1 illustrates a schematic diagram of a wire bond pull test apparatus;

FIG. 2 illustrates a schematic diagram of another wire bond pull test apparatus;

FIG. 3A illustrates a schematic diagram of an example of the first clamping element and the second clamping element;

FIG. 3B illustrates a schematic diagram of another example of the first clamping element and the second clamping element;

FIG. 4 illustrates a block diagram of an example of the electronic circuit of the apparatus;

FIG. 5 illustrates a schematic diagram of an example of the wire bond pull test equipment;

FIG. 6 illustrates a schematic diagram of another example of the wire bond pull test equipment;

FIG. 7 illustrates a diagram of an example of clamping operation and the possible results during a vertical tensile strength testing; and

FIG. 8 illustrates a flow chart of an example of a method for a vertical tensile strength testing using the proposed apparatus.

The appended drawings are intended to provide further understanding of the configurations of the invention. They illustrate configurations and, in conjunction with the description, help to explain principles and concepts of the invention. Other configurations and many of the advantages mentioned become apparent in view of the drawings. The elements in the drawings are not necessarily shown to scale.

In the drawings, like functionally equivalent and identically operating elements, features and components are provided with like reference signs in each case, unless stated otherwise.

### DETAILED DESCRIPTION OF CERTAIN EMBODIMENTS

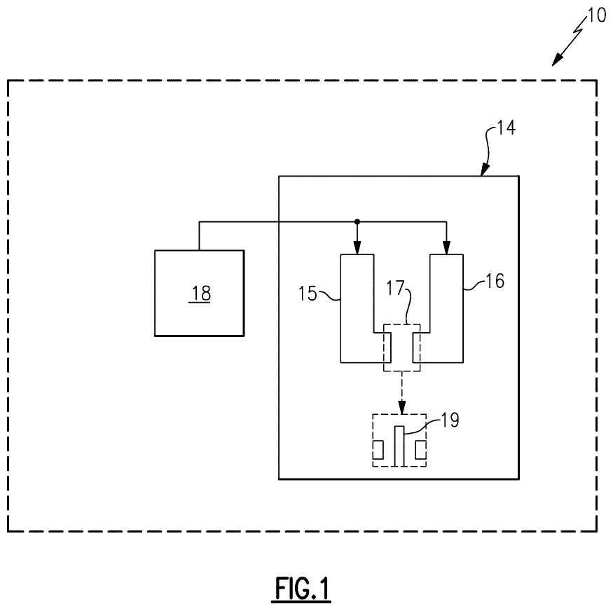

FIG. 1 illustrates a schematic diagram of an example of wire bond pull test apparatus.

In FIG. 1, the wire bond pull test apparatus for detecting a bond failure or wire breakage during a vertical tensile strength testing of bonded wire under test in FIG. 1 is denoted by reference numeral 10. The wire bond pull test apparatus 10 shown in FIG. 1 includes a clamp structure 14 including a first clamping element 15 and a second clamping element 16 and a controllable actuator 18.

The first clamping element 15 and the second clamping element 16 arranged substantially parallel to each other and defining an opening 17 for placing a single-end bonded wire under test 19 between the first clamping element 15 and the second clamping element 16. The at least one of the first clamping element 15 and the second clamping element 16 is configured to enable a movement towards or from each other, such to clamp the single-end bonded wire under test 19 in the opening 17 between the first clamping element 15 and the second clamping element 16 and release the single-end bonded wire under test 19, respectively.

The controllable actuator 18 coupled to at least one of the first clamping element 15 and the second clamping element 16, which the controllable actuator 18 is arranged and configured to drive the movement of the first clamping element 15 and second clamping element 16 relative to each other such that the single-end bonded wire under test 19 is clamped in the opening 17 between the first clamping element 15 and the second clamping element 16 and released, respectively.

In the present disclosure, a wire pull test is performed on a single connection wire, e.g. a vertical bonded wire, such that it can achieve a comparable accuracy and precision without employing a double-end bonding pull test. The wire bond pull test for the single-end bond wire under test enables an early detection of the issues regarding to the wire strength after bonding, enhances the wire bond stability by determining the wire pull strength especially during the machine setup or device conversion, reduces the risk of single-end bonded wire for a broken wire, inconsistent tail, and sticky wire by defining the most optimal parameters setting based on the test result, as well as improves the productivity and the overall effectivity of machine.

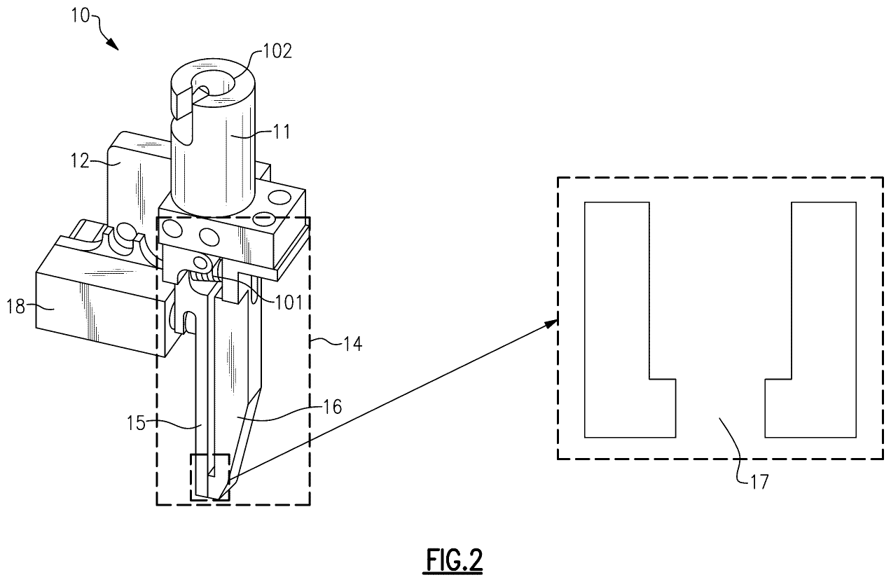

FIG. 2 illustrates a schematic diagram of another example of wire bond pull test apparatus 10.

The wire bond pull test apparatus 10 shown in FIG. 2 includes base connector 11 comprising a test interface 102, a clamp structure 14 including a first clamping element 15 and a second clamping element 16, a controllable actuator 18, a spring 101 and a support element 12.

The base connector 11 is coupled to the clamp structure 14. The test interface 102 is configured to couple the apparatus to an external wire bond pull test equipment (not shown in the current figure). When different testing apparatuses need to be arranged on the wire bond pull test equipment 74, only the base connector 11 needs to be detached without further disassembly of other components of the apparatus 10. Similarly, the base connector 11 can be attached to the wire bond pull test equipment 74. This enables the reuse of one test equipment for different testing needs.

The clamp structure 14 coupled to the base connector 11 and the clamp structure 14 includes a first clamping element 15 and a second clamping element 16 arranged substantially parallel to each other and defining an opening 17 for placing a single-end bonded wire under test 19 between the first clamping element 15 and second clamping element 16, wherein at least one of the first clamping element 15 and the second clamping element 16 is configured to enable a movement towards or from each other, such to clamp the single-end bonded wire under test 19 and release the single-end bonded wire under test 19, respectively. Between the base connector 11 and the clamp structure 14 it may further comprise a mechanical or electrical coupling mean for joining those two components.

The controllable actuator 18 may be a solenoid and comprise a housing. A solenoid is a type of electromagnet formed by a helical coil of wire whose length is substantially greater than its diameter, which generates a controlled magnetic field. The coil can produce a uniform magnetic field in a volume of space when an electric current is passed through it. A solenoid may serve as a mechanism to apply or release force based on the electrical input. As such, the clamp and release operation of the clamp structure may be controlled through the electronically control of the solenoid, which may offer precise control over the force and speed of the clamp and release operation. It may also have the potential to allow for automation in various application. The at least one solenoid may be electrically coupled to the controllable actuator 18. The controllable actuator 18 may comprise other electronic control elements to perform the driving of the movement of the first clamping element 15 and second clamping element 16. The at least one solenoid could be electrically coupled to other electronic control elements of the controllable actuator to realize relative fast control and communication process. The at least one solenoid may be electrically and mechanically hybrid coupled to the controllable actuator 18. The controllable actuator 18 may comprise other electronic or mechanical control elements to perform the driving of the movement of the first clamping element 15 and the second clamping element 16. The at least one solenoid could be electrically and mechanically hybrid coupled to other control elements of the controllable actuator to improve the flexible design of controllable actuator and the efficiency of heat dissipation.

The support element 12 arranged between the base connector 11 and the controllable actuator 18 so as to provide a mechanical support for the controllable actuator 18. The mechanical support 12 may be a bracket, a brace, a frame or the like. Mechanical support between the base connector 11 and the controllable actuator 18 ensures that apparatus 10 remains stable during the testing. It may offer proper alignment and protection of the apparatus 10 from collapsing when the apparatus 10 is under malfunction. It may also help to reduce vibrations and associated noise during the testing.

The apparatus 10 further comprises a spring 101 arranged between the first clamping element 15 and the second clamping element 16 and configured to assist to maintain a correct tension on the single-end bonded wire under test 19, in case the single-end bonded wire under test 19 is clamped in the opening defined by the first clamping element 15 and the second clamping element 16. The spring-arranged clamping elements may assist to maintain the correct tension on the wire, preventing slack or excessive tightness, which could negatively affected the wire under test, such as leading to poor test performance, wire deformation or wire breakage in between the clamp.

The apparatus 10 performs a wire pull test on a single connection wire, such as a vertical wire, that can achieve the same accuracy and precision as the double-end bonding pull test. It is also easy to use and cost-effective. The wire bond pull test for the single-end bond wire enables an early detection of the issues regarding to the wire strength after bonding, enhances the wire bond stability by determining the wire pull strength especially during the machine setup or device conversion, reduces the risk of single-end bonded wire for a broken wire, inconsistent tail, and sticky wire by defining the most optimal parameters setting based on the test result, as well as improves the productivity and the overall effectivity of machine.

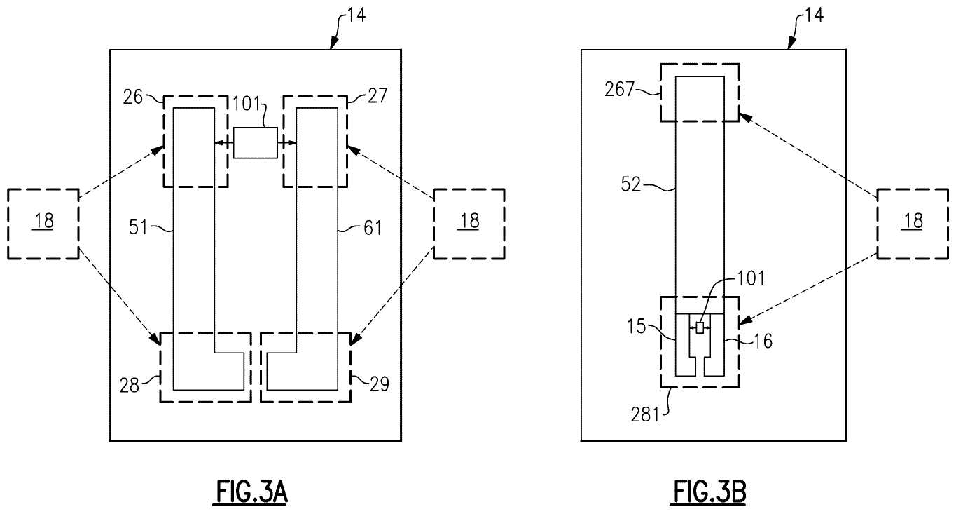

FIG. 3A illustrates a schematic diagram of an example of the first clamping element 15 and the second clamping element 16 and FIG. 3B illustrates a schematic diagram of another example of the first clamping element 15 and the second clamping element 16.

In FIG. 3A, the first clamping element 15 and the second clamping element 16 are a first elongated arm 51 and a second elongated arm 61, respectively. The first elongated arm 51 and second elongated arm 61 may be two symmetrical and separable elongated arm, which are joined with a spring 101. The first elongated arm 51 comprises a first proximal end 26 and a first distal end 28 and the second elongated arm 61 comprises a second proximal end 27 and a second distal end 29 such that the first proximal end 26 and the second proximal end 27 are joined with the spring 101 arranged between the first elongated arm 51 and the second elongated arm 61. The controllable actuator 18 may be coupled to at least one proximal end 26, 27 or at least one distal end 28, 29 to control the movement of the clamping elements. The first distal end 28 and the second distal end 29 of the first elongated arm 51 and the second elongated arm 61 may have a smaller or equal cross section area than the first proximal end 26 of a first elongated arm 51 and the second proximal end 27 of the second elongated arm 61. The first distal end 28 and the second distal end 29 of the first elongated arm 51 and the second elongated arm 61 may have a pair of point-shaped tips, a pair of a slant-shaped tips, a pair of a pointed-slant-shaped tips, a pair of a round-shaped tips, a pair of a square-shaped tips, or the like. It can be adapted to different kinds of test wire, providing a larger range of test types.

This example of the first clamping element and the second clamping element defines a boarder opening between the first clamping element and the second clamping element, thus it may provide a more flexible and easy-to-repair structure and increase degree of freedom of operation.

In FIG. 3B, the clamp structure 14 comprises an elongated arm 52 comprises a proximal end 261 coupled to the base connector 11. The elongated arm 52 further comprises a distal end 281 comprising two branches. Those two branches may be the first clamping element 15 and the second clamping element 16. The first clamping element 15 and the second clamping element 16 may be joined with a spring 101. The spring-arranged clamping elements may assist to maintain the correct tension on the wire, preventing slack or excessive tightness, which could negatively affected the wire under test, such as leading to poor test performance, wire deformation or wire breakage. The controllable actuator 18 may be coupled to the proximal end 261 or the distal end 281 to control the movement of the clamping elements. It defines a more compact design of the apparatus. It may provide more precise operations and avoid disoperation. It simplified the design and reduce the weight of the clamp structure. It may further achieve a more compact design and a more cost-effective stability design by further adopting less construction material but have enough stability.

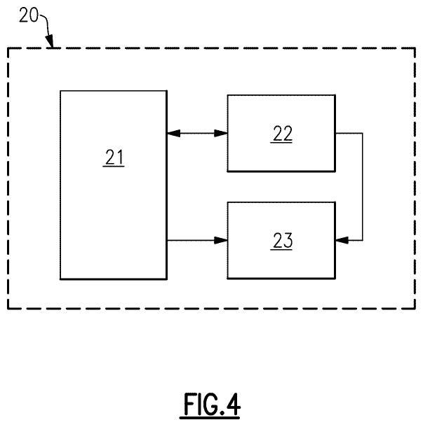

FIG. 4 illustrates a block diagram of an example of the electronic circuit of the apparatus.

The apparatus 10 further comprises at least one electronic circuit 20 coupled to the controllable actuator 18, or being part of the controllable actuator 18. The electronic circuit 20 may comprise different combinations of the following circuits according to different use context: a power supply circuit 21, a controller circuit 22, a timer circuit 23. A power supply circuit 21 is an electrical circuit that supplies electric power to any circuit that need electrical power. It may convert electric current from a source to correct voltage, current and frequency to power the load and may a programmable power supply circuit to supply power more precisely and efficiently. A controller circuit 22 is an electronic circuit that designed to manage and regulate the operation of other devices or systems. It receives input signals, processes them, and generates output signals to manage and regulate the behavior, status or signals of the connected components. It may be a microcontroller comprising at least one processor cores along with memory and programmable input/output peripherals. It may be a separate control circuit that manages the access and distribution of the memory that sends control signals to other electronic circuit units. A timer circuit 23 is a type of clock that starts from a specified time duration and stops when reaching the setting time limit. It can be implemented through hardware with mechanical or electromechanical mechanism. It can be implemented through software with a programmable logic controller. A timer circuit 23 may start counting down with a predetermined time period for each operation of the vertical tensile strength testing, such that when no operation is conducted or completed with the predefined time period of countdown, the apparatus 10 is configured to be reset to a default position or be cut off from a power supply. As such, it can save the energy of the apparatus 10. The electronic circuit 20 can be electrically coupled to the controllable actuator 18 in order to achieve a more flexible design of the apparatus 10, or at least partially integrated with the controllable actuator 18 in order to achieve a more compact design of the apparatus 10.

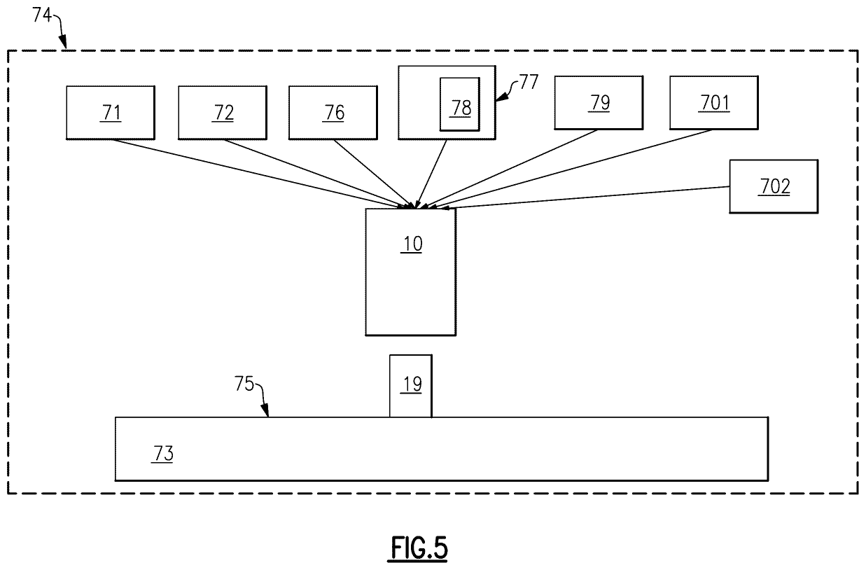

FIG. 5 illustrates a schematic diagram of an example of the wire bond pull test equipment.

The wire bond pull test equipment for detecting a bond failure or wire breakage during a vertical tensile strength testing of bonded wire samples in FIG. 5 is denoted by reference numeral 74. The wire bond pull test equipment 74 shown in FIG. 5 comprises a wire bond testing platform 73 comprising a test area 75 which is configured to receive a single-end bonded wire under test 19 and at least one wire bond pull test apparatus 10 coupled to the wire bond pull test equipment 74.

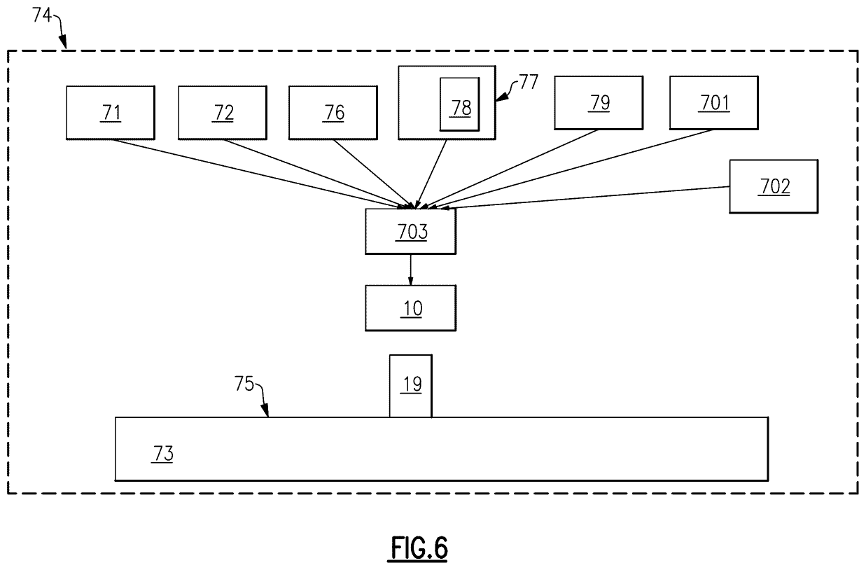

FIG. 6 illustrates a schematic diagram of another example of the wire bond pull test equipment.

As shown in FIG. 6, alternatively, the at least one bond pull test apparatus 10 can also be coupled to the wire bond pull test equipment 74 via a wire pull cartridge 703.

The equipment 74 may comprise a pulling unit 71, which is configured to apply an upwards directed force to the apparatus 10 to conduct the vertical tensile strength testing when the single-end bonded wire under test 19 is clamped in the opening 17 between the first clamping element 15 and the second clamping element 16. The single-end bonded wire under test 19 should be placed in the middle of the opening 17 defined by the first clamping element 15 and the second clamping element 16, which the clamping can be performed suitably without inappropriate operations. The pulling force applied to the apparatus 10 should be directed along the axial upward direction of the single-end bond wire under test 19, and should not be applied in any other direction. Thus, the test time may be saved and test efficiency may be improved.

The test equipment 74 may comprise a detection unit 72. The detection unit 72 is configured to record at least one test result. The detection unit 72 may ensure that testing result is recorded in real-time and an in time decision on the testing could be made.

The test equipment 74 may comprise a timer unit 76. The timer unit 76 is configured to generate a predefined time period of countdown for each operation of the vertical tensile strength testing, such that when no operation is conducted or completed with the predefined time period of countdown, the apparatus is configured to be reset to a default position or be cut off from a power supply. While the timer circuit 23 of the apparatus may focus on more the clamp and release movement of the clamp structure, the timer unit 76 of the test equipment may more concentrate on the pull testing operation. However, the timer unit 76 of the test equipment 74 and the timer circuit 23 of the apparatus 10 may be a substitute or a backup for each other. The timer countdown function is essential for the vertical tensile strength testing, it not only can save the energy of the testing process but also may ensure testing safety when the testing process is out of supervision.

The test equipment 74 may comprise an evaluation device 77, which is configured to evaluate whether the vertical tensile strength testing comprises at least one failure. A ball lift result may represent a wire pull failure. The ball lift occurrence indicates that the ball to bond pad interface is very weak. Poor wire bonder set-up and bond pad surface contamination are primary causes of ball lifting. Under the influence of this result, the test does not yield a sufficient time to be performed in order to yield further tensile test results. Other failures may be setting failures, operation failures or at least one malfunction, the arrival predefined time period of countdown or the like. The evaluation device can also indicate how strong a pull force applies to the device under test.

The test equipment 74 may comprise a warning unit 78, which is configured to generate at least one warning message in case the evaluation device has detected a failure. Under the at least one failure, the warning unit 78 may send a warning message via test equipment or via wired or wireless communication to an external device.

The test equipment 74 further comprises an output unit 79, which is configured to output at least one test record of the vertical tensile strength testing. The output unit 79 may output the at least one test record comprising at least one of the following information: the system settings, test result, and failure. It may further comprise warning message or test logs. The system settings may include some permanent or non-permanent information of the test equipment. The test logs may comprise some information about the testing process or debug process. The test record may be output stepwise, which the test record may focus on one apparatus. The test record may be output with time-based, since different time slots there may be different test apparatuses on the run. Detailed test record may improve maintenance efficiency of the test equipment.

The output unit 79 may comprise at least one screen coupled to or at least partially embedded in the equipment 74. The at least one screen can be liquid-crystal display screen or at least one touch screen. The liquid-crystal display screen can display a certain selected test record on site. The touch screen increases a human-machine interface, which make the operation of the test equipment more efficient. The output unit 79 may comprise at least one output interface, which the at least one output interface is configured to transport the test record to an external device with wire or wirelessly. The test record may comprise a large amount of test files, which may be displayed limited with the screen coupled to or at least partially embedded in the equipment 74. Therefore, the test record may be transferred wired or wirelessly to an external device which can present more test files.

The test equipment 74 may comprise further a memory 701 configured to storage at least one test record. The memory 701 may be volatile or non-volatile. The test record may also be stored on a cloud memory, which can achieve a simultaneous cooperation between multiple people. In this case, the memory unit may storage only the permanent information on testing and the address information of the local or external web server that hold the test record. Thus, the memory space can be largely saved and the equipment is more cost effective.

The test equipment 74 may comprise a processor 702 configured to process the test record such that the test record is represented by a machine readable code. The machine-readable code may be a barcode, a matrix code, a quick response code or the like. The content of the test record may be directly encoded in the machine-readable code, or the address of the locally or external web server that storage the test record may be encoded in the machine-readable code. The machine-readable code may be displayed on the screen of the test equipment, it may also be transported to an external device. A device with a machine-readable code scanning function can scan and decode the information encoded in the machine-readable code. Therefore, the test recode can be more easily transported in different devices.

It is notable that the functions of the timer circuit of the electronic circuit of the apparatus and the functions of the timer unit, can form alternatives to each other or complement each other.

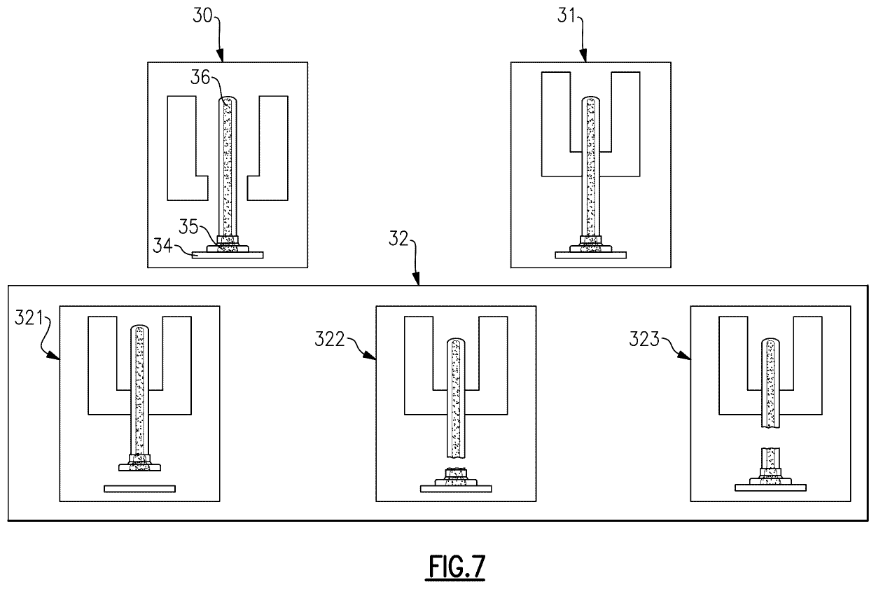

FIG. 7 illustrates a diagram of an example of clamping operation and the possible results during a vertical tensile strength testing.

FIG. 7 illustrates the clamping operation before the vertical tensile strength testing 30 and during the vertical tensile strength testing 31. FIG. 7 further includes the possible results after the vertical tensile strength testing 32. The possible results comprise ball lift 321, neck break 322 and wire break 323.

Before the vertical tensile strength testing 30, the vertical bonded wire 36 should be placed centered to opening 17 between the first clamping element 15 and the second clamping element 16. During the vertical tensile strength testing 31, the first clamping element 15 and the second clamping element 16 move towards each other. The vertical bonded wire 36 is applied with an upwards force to conduct the vertical tensile strength testing when the vertical bonded wire 36 is clamped in the opening 17 between the first clamping element 15 and second clamping element 16 properly, wherein a result 32 of the vertical bonded wire device under test is at least one of the following: ball lift 321, neck break 322, wire break 323. The vertical tensile strength testing usually involving two types of testing: destructive test and non-destructive test. Destructive testing involves testing until the test object is destroyed. The force applied is recorded. In the non-destructive test, the test continues until a previously defined force is reached. This force is held for a certain period of time and then released again. The vertical tensile strength testing ensures that wire bonds meet the required strength standards, reducing the risk of premature failure and increasing product reliability.

Ball lift 321, neck break 322 and wire break 323 are destructive test result. The ball lift 321 occurrence indicates that the ball 35 to bond pad 34 interface is very weak. Poor wire bonder set-up and bond pad surface contamination are primary causes of ball lifting. Poor set-up includes improper parameter settings, unstable work piece holders, and worn-out tools. These result in poor initial welding and inadequate intermetallic formation between the bond pad 34 and the ball bond 35. Neck break 322 test result is a pull test break mode that breaks in between the wire and the ball bond. Neck break 322 test result is considered to be of good adhesion between the ball bond and the surface of the bonding pad. The neck break 322 pull test result indicates that the pull test strength is high versus the specification of the pulling force applied during the pull test. Wire break 323 is a pull test break mode that breaks anywhere in between the wire. Wire break 323 is considered to be of good adhesion between the ball bond and the surface of the bonding pad. Usually the wire break 323 test result gives the highest bond pull value, closing to the ultimate tensile strength of the wire and indicating that the pull test strength is the highest among all the pull testing measurement.

Sometimes, the vertical tensile strength testing may follow a bond shear test. A quality ball bond can withstand up to ten times the wire pull destruct force but a low quality bond will still take more force to pull off than a wire pull test. Ball shear testing is used to assess the integrity of the ball-to-bonding pad interface in the ball bonding process. It is also a destructive test. Ball shear data reflects the intermetallic formation and its coverage of bonds. It is measured by gram force over the area of the ball formation.

A ball lift 321 result represents a wire pull failure. Under the influence of this result, the test does not yield a sufficient time to be performed in order to yield further tensile test results.

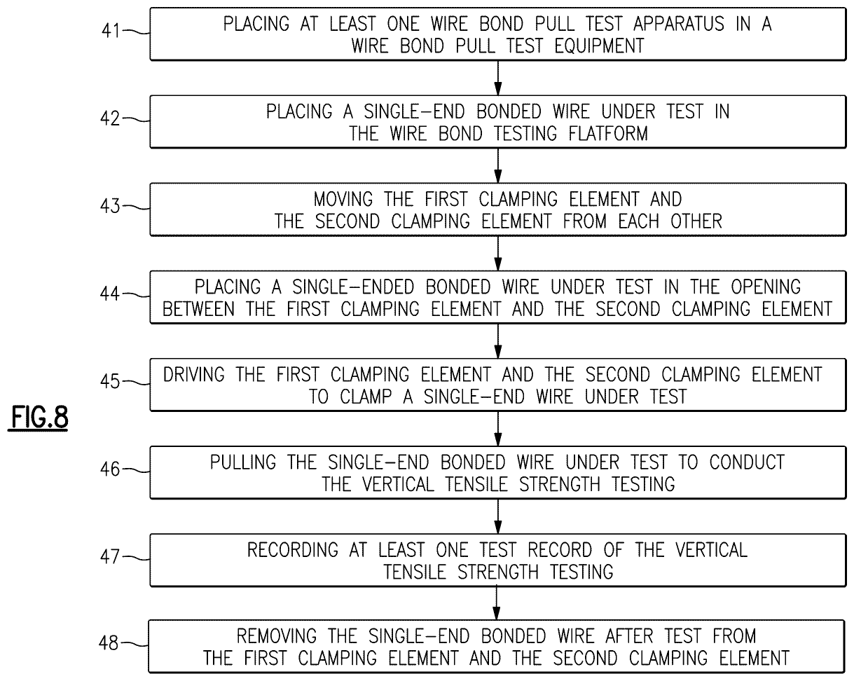

FIG. 8 illustrates a flow chart of an example of a method for a vertical tensile strength testing using the proposed apparatus.

Step 41 is that placing at least one wire bond pull test apparatus in a wire bond pull test equipment for detecting a bond failure or wire breakage during the vertical tensile strength testing of bonded wire under test. It may comprise setting up and calibrating the wire bond testing platform, installing the apparatus into the wire bond testing platform and plugging in the power source of the apparatus. Step 42 is that placing a single-end bonded wire under test in the wire bond testing platform, ensuring the single-end bonded wire under test would place properly in the opening 17 between the first clamping element 15 and the second clamping element 16. Step 43 is that moving the first clamping element 15 and the second clamping element 16 from each other such to increase an opening 17 between the first clamping element 15 and the second clamping element 17. Step 44 is that placing a single-end bonded wire under test 19 in the opening 17 between the first clamping element 15 and the second clamping element 16. Step 45 is that driving the first clamping element 15 and the second clamping element 16 to clamp a single-end wire under test 19. Step 46 is that pulling the single-end bonded wire under test 19 to conduct the vertical tensile strength testing. Step 47 is that recording at least one test record of the vertical tensile strength testing.

It may further comprises step 48: removing the single-end bonded wire after test from the first clamping element and the second clamping element so that the first clamping element and the second clamping element are configured to be closed by default. A stray pulled single-end bonded wire is removed from the first clamping element and the second clamping element so that the first clamping element and the second clamping element are configured to be closed by default. During a tensile test, the single-end bonded wire under test may be deformed or broken by pulling, and usually the single-end bonded wire under test is no longer suitable for use in the facility and should be discarded. Usually at the completion of a vertical tensile strength testing, more or less stray pulled test wires remain on the clamping elements. The diameter of these test wires is usually close to the micron level, and a very small amount of test residue on the clamping elements can have a negative effect on the next test. The removal of the stray pulled single-end bonded wire from the first clamping element and the second clamping element can be used with physical disposal or chemical rinsing, such as be dumped on a trash bin or removed with ultrasonic rinsing, so as to prevent the test residue on the clamping elements from having a negative effect on the next test and to enable the clamping elements back to their default positions without the effect of test residue to save energy and extend the lifespan of the apparatus.

Unless the context clearly requires otherwise, throughout the description and the claims, the words “comprise,” “comprising,” “include,” “including” and the like are to be constructed in an inclusive sense, as opposed to an exclusive or exhaustive sense; that is to say, in the sense of “including, but not limited to.” The word “arranged”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, fall refer to this application as a whole and not to any particular portions of this application. Where the context permits, words in the above detailed description of certain configurations using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or whether these features, elements and/or states are included or are to be performed in any particular configuration.

While certain configurations have been described, these configurations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative configurations may perform similar functionalities with different components and/or circuit topologies, and same blocks may be deleted, moved, added, subdivided, combined, and/or modified. Each of these blocks may be implemented in a variety of different ways.

Any suitable combination of the elements and acts of the various configurations described above can be combined to provide further configurations. The accompanying claims and their equivalents are intended to cover such forms or modifications as would fall within the scope and spirit of the disclosure.

1. A wire bond pull test apparatus for detecting a bond failure or wire breakage during a vertical tensile strength testing of a bonded wire under test, the test apparatus comprising:
a clamp structure including a first clamping element and a second clamping element, the first clamping element and the second clamping element arranged substantially parallel to each other and defining an opening for placing a single-end bonded wire under test between the first clamping element and the second clamping element, and at least one of the first clamping element and the second clamping element being configured to enable a movement towards and from each other such to clamp the single-end bonded wire under test in the opening between the first clamping element and the second clamping element and to release the single-end bonded wire under test, respectively; and
a controllable actuator coupled to at least one of the first clamping element and the second clamping element, the controllable actuator arranged and configured to drive the movement of the first clamping element and the second clamping element relative to each other such that the single-end bonded wire under test is clamped in the opening between the first clamping element and the second clamping element and released, respectively.

2. The test apparatus of claim 1 wherein the controllable actuator includes at least one solenoid.

3. The test apparatus of claim 2 further comprising at least one controller circuit that is electrically coupled to the at least one solenoid, or electrically and mechanically hybrid coupled to the at least one solenoid.

4. The test apparatus of claim 1 further comprising at least one controller circuit electrically coupled to the controllable actuator, or being part of the controllable actuator.

5. The test apparatus of claim 1 wherein the opening defined by the first clamping element and the second clamping element has a cross section, the shape of the cross section of the opening corresponding to the shape of the cross section of a single-end bonded wire under test.

6. The test apparatus of claim 1 further comprising a spring arranged between the first clamping element and the second clamping element, so that in a clamped condition of the single-end bonded wire under test the spring is configured to exert a predefined force on the single-end bonded wire under test.

7. The test apparatus of claim 1 wherein the first clamping element and the second clamping element are further configured to be moveable relative to each other along a direction that is perpendicular to the single-end bonded wire under test.

8. The test apparatus of claim 1 wherein at least one of the first clamping element and the second clamping element has a rough surface which is configured such to prevent skidding of a single-end bond wire under test which is clamped in the opening between the first clamping element and the second clamping element.

9. The test apparatus of claim 1 further comprising a base connector coupled to the clamp structure and including a test interface which is configured to couple the test apparatus to an external wire bond pull test equipment.

10. The test apparatus of claim 1 wherein the first clamping element and the second clamping element include a first elongated arm and a second elongated arm, respectively, the first elongated arm includes a first proximal end and a first distal end, and the second elongated arm includes a second proximal end and a second distal end, a spring being arranged between the first proximal end and the second proximal end.

11. The test apparatus of claim 1 wherein the clamp structure includes an elongated arm that has a proximal end and a distal end, the distal end including the first clamping element and the second clamping element, a spring being arranged between the first clamping element and the second clamping element.

12. A wire bond pull test equipment for detecting a bond failure or wire breakage during a vertical tensile strength testing of a bonded wire under test, the test equipment comprising:
a wire bond testing platform including a test area which is configured to receive a single-end bonded wire under test;
at least one wire bond pull test apparatus for detecting a bond failure or wire breakage during the vertical tensile strength testing of the bonded wire under test coupled to the wire bond pull test equipment, the test apparatus including:
a clamp structure including a first clamping element and at least one second clamping element, the first clamping element and the second clamping element being arranged substantially parallel to each other and defining an opening for placing a single-end bonded wire under test between the first clamping element and the second clamping element, and at least one of the first clamping element and the second clamping element being configured to enable a movement towards and from each other such to clamp the single-end bonded wire under test in the opening between the first clamping element and the second clamping element and to release the single-end bonded wire under test, respectively; and
a controllable actuator coupled to at least one of the first clamping element and the second clamping element, the controllable actuator being arranged and configured to drive the movement of the first clamping element and the second clamping element relative to each other such that the single-end bonded wire under test is clamped in the opening between the first clamping element and the second clamping element and released, respectively.

13. The test equipment of claim 12 further comprising a pulling unit which is configured to apply an upward directed force to the test apparatus to conduct the vertical tensile strength testing when the single-end bonded wire under test is clamped in the opening between the first clamping element and the second clamping element.

14. The test equipment of claim 12 further comprising a detection unit configured to record at least one test result, the at least one test result being at least one of ball lift, neck break, and wire break.

15. The test equipment of claim 12 further comprising a timer unit which is configured to generate a predefined time period for a countdown for each operation of the vertical tensile strength testing such that, when no operation is conducted or completed within the predefined time period, the test apparatus is configured to be reset to a default position or to be cut off from a power supply.

16. The test equipment of claim 12 further comprising an evaluation device configured to evaluate whether the vertical tensile strength testing includes at least one failure, and a warning unit configured to generate at least one warning message or warning signal in case the evaluation device has detected a failure.

17. The test equipment of claim 12 further comprising an output unit configured to output at least one test record of the vertical tensile strength testing, the at least one test record including at least one of system settings, a test result, and information about failure.

18. The test equipment of claim 17 further comprising a memory configured to store at least one test record.

19. A test method for detecting a bond failure or wire breakage during a vertical tensile strength testing of a bonded wire under test, the test method comprising:
placing at least one wire bond pull test apparatus in a wire bond pull test equipment for detecting a bond failure or wire breakage during the vertical tensile strength testing of bonded wire under test;
placing a single-end bonded wire under test in a wire bond testing platform of the wire bond pull test equipment;
moving a first clamping element and a second clamping element from each other such to increase an opening between the first clamping element and the second clamping element;
placing a single-end bonded wire under test in the opening between the first clamping element and the second clamping element;
driving the first clamping element and the second clamping element to clamp a single-end wire under test;
pulling the single-end bonded wire under test to conduct the vertical tensile strength testing; and
recording at least one test record of the vertical tensile strength testing.

20. The test method of claim 19 further comprising removing the single-end bonded wire after test from the first clamping element and the second clamping element so that the first clamping element and the second clamping element are configured to be closed by default.
